(19) United States
(12) Patent Application Publication
(10) Pub. No.: US 2009/0276281 A1
(43) Pub. Date: Nov. 5, 2009

(54) METHOD, SYSTEM, AND COMPUTER PROGRAM PRODUCT FOR EFFECTIVE TASK MANAGEMENT

(75) Inventors: Christopher T. Foltz, Poughkeepsie, NY (US); Eduardo M. Koster Abad, Poughkeepsie, NY (US); Sreekanth Ramakrishnan, Wappingers Falls, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/112,922

(22) Filed: Apr. 30, 2008

(51) Int. Cl. G06Q 10/00

(52) U.S. Cl. 705/9

(57) ABSTRACT

A method for effective employee assignment including determining a number of employees needed to perform each of a plurality of tasks, determining a skill flexibility index (SFI) of each employee, determining a job quality index (JQI) of each employee, determining a minimum acceptable (min. JQI) for each task, and for each task, in an order from highest min. JQI to lowest min. JQI, assigning each employee to the task having a JQI higher than or equivalent to the min. JQI in an order from each employee with a lower SFI and a higher JQI to an employee with a higher SFI and a lower JQI until the number of employees needed to perform the task is assigned or there are no more available employees to assign to the task having a JQI higher than or equivalent to the min. JQI of the task. A corresponding system and computer program product.

### BACKGROUND OF THE INVENTION

1. Field of the Invention

This invention relates generally to business management, and particularly to a method, system, and computer program product for effective employee assignment.

2. Description of Background

Effective employee assignment is a challenging task in the management of a business or other organization. For example, in large companies with numerous employees, effectively assigning the employees to various job tasks (such as projects or other responsibilities) can be very complicated. For effective employee assignment, it is desirable to assign employees to job tasks based on their skills and performance in a manner that ensures that the results of the tasks (e.g., the resulting products or services) meet applicable quality standards. However, the complexity of identifying employee skill and performance levels and appropriately matching them to job tasks may be overwhelming, thereby causing a manager to ineffectively assign employees to tasks (e.g., randomly or based on less or non-relevant factors). Furthermore, identifying employee needs for improvement of skills or performance based on the needs and opportunities of a business can also be overwhelmingly complex, resulting in the ineffective application of training and other management action. Therefore, an approach is desirable that simplifies these and other aspects of effective employee assignment.

### SUMMARY OF THE INVENTION

A method, system, and computer program product for effective employee assignment is provided. An exemplary method embodiment includes determining a number of employees needed to perform each of a plurality of tasks based on a demand amount for each task, determining a skill flexibility index of each of the employees including a scaled index of a total number of skill certifications of each employee to perform the plurality of tasks, determining a job quality index of each of the employees including a scaled index of a job performance quality rating of each employee, determining a minimum acceptable job quality index for each of the plurality of tasks, and for each task, in an order from the task with a highest minimum acceptable job quality index to the task with a lowest minimum acceptable job quality index, assigning each employee to the task that has a job quality index that is higher than or equivalent to the minimum acceptable job quality index of the task in an order from each employee with a lower skill flexibility index and a higher job quality index to an employee with a higher skill flexibility index and a lower job quality index until the number of employees needed to perform the task is assigned or there are no more available employees to assign to the task that have a job quality index that is higher than or equivalent to the minimum acceptable job quality index of the task. A corresponding system embodiment and computer program product embodiment is also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured for effective employee assignment.

FIG. 2 is a block diagram illustrating an example of a subsystem of the exemplary computer system of FIG. 1 that is configured for effective employee assignment.

FIG. 3 is a flow diagram illustrating an example of a method for effective employee assignment, which is executable, for example, on the exemplary computing device of FIG. 1.

FIGS. 4A and 4B are tables listing exemplary computation parameters and results of the number of employees needed to perform a plurality of job tasks, for example, in accordance with the exemplary method of FIG. 3.

FIG. 5 is a table listing exemplary computation parameters and results of a skill flexibility index for a plurality of employees, for example, in accordance with the exemplary method of FIG. 3.

FIG. 6 is a table listing exemplary computation parameters and results of a job quality index for a plurality of employees, for example, in accordance with the exemplary method of FIG. 3.

FIG. 7 is a table listing exemplary computation parameters and results of a resource deployment index for a plurality of employees, for example, in accordance with the exemplary method of FIG. 3.

FIG. 8 is an exemplary matrix record listing assignments of employees to a plurality of tasks, for example, in accordance with the exemplary method of FIG. 3.

The detailed description explains the preferred embodiments of the invention, together with advantages and features, by way of example with reference to the drawings.

### DETAILED DESCRIPTION OF THE INVENTION

According to exemplary embodiments of the invention described herein, a method, system, and computer program product for effective employee assignment is provided. In accordance with such exemplary embodiments, an approach is provided that simplifies aspects of effective employee assignment including identifying employee skill and performance levels, effectively assigning employees to job tasks in accordance with such levels, and identifying employee needs for improvement of skills or performance based on the needs and opportunities of a business. Benefits provided by such exemplary embodiments include: 1) a proactive approach to resource assignment addressing the future needs of a business in a dynamic environment; 2) combining both employee skill flexibility and performance (e.g., job quality) to give a holistic recommendation for deployment; 3) making recommendations for employee training based on needs and to facilitate employees penetrating into job “channels” based on like skills; 4) identifying risks to the resource plans of a business from both a quality perspective and skill rigidity; and 5) offering a unique resource deployment index as a deployment tool as well as a performance metric for management action.

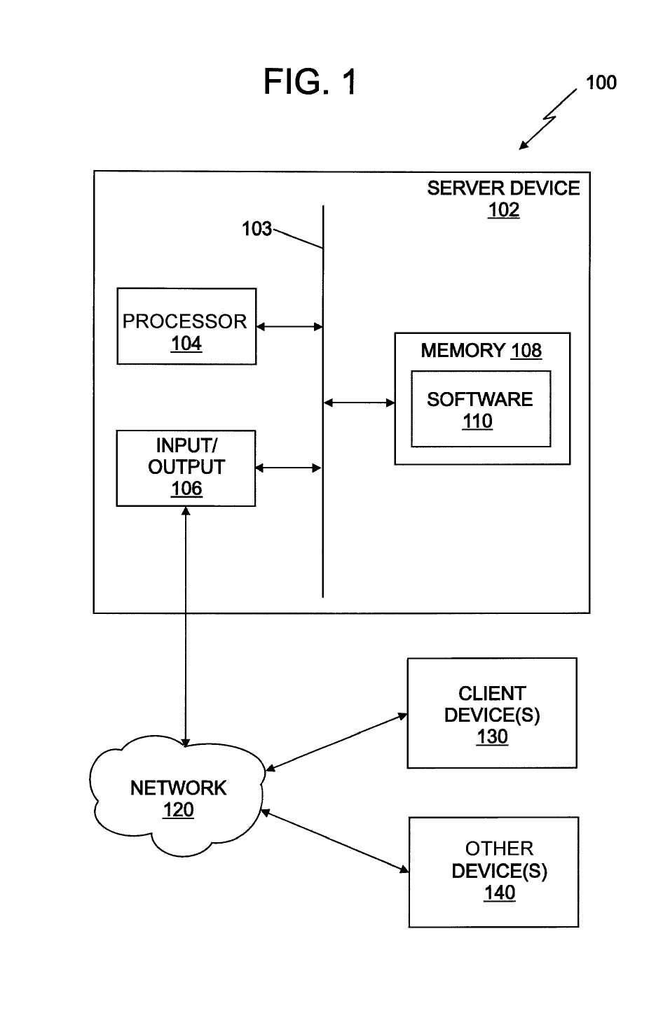

Turning now to the drawings in greater detail, wherein like reference numerals indicate like elements, FIG. 1 illustrates an example of a computer system 100 including an exemplary computing device (“server device” or “server”) 102 configured for effective employee assignment. In addition to server device 102, exemplary computer system 100 includes network 120, client device(s) 130, and other device(s) 140. Network 120 connects server device 102, client device(s) 130, and other device(s) 140 and may include one or more wide area networks (WANs) and/or local area networks (LANs) such as the Internet, intranet(s), and/or wireless communications network(s). Client device(s) 130 may include one or more other computing devices, e.g., that are similar to server device 102. Other device(s) 140 may include one or more other computing devices, e.g., one or more other server devices, storage devices, etc. Server device 102, client device(s) 130, and other device(s) 140 are in communication via network 120, e.g., to communicate data between them.

Exemplary server device 102 includes processor 104, input/output component(s) 106, and memory 108, which are in communication via bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from server device 102, such as a display, keyboard, modem, network adapter, ports, etc. (not depicted). Memory 108 includes software 110 for effective employee assignment, which is executable, e.g., by server device 102 via processor 104. Memory 108 may include other software, data etc. (not depicted).

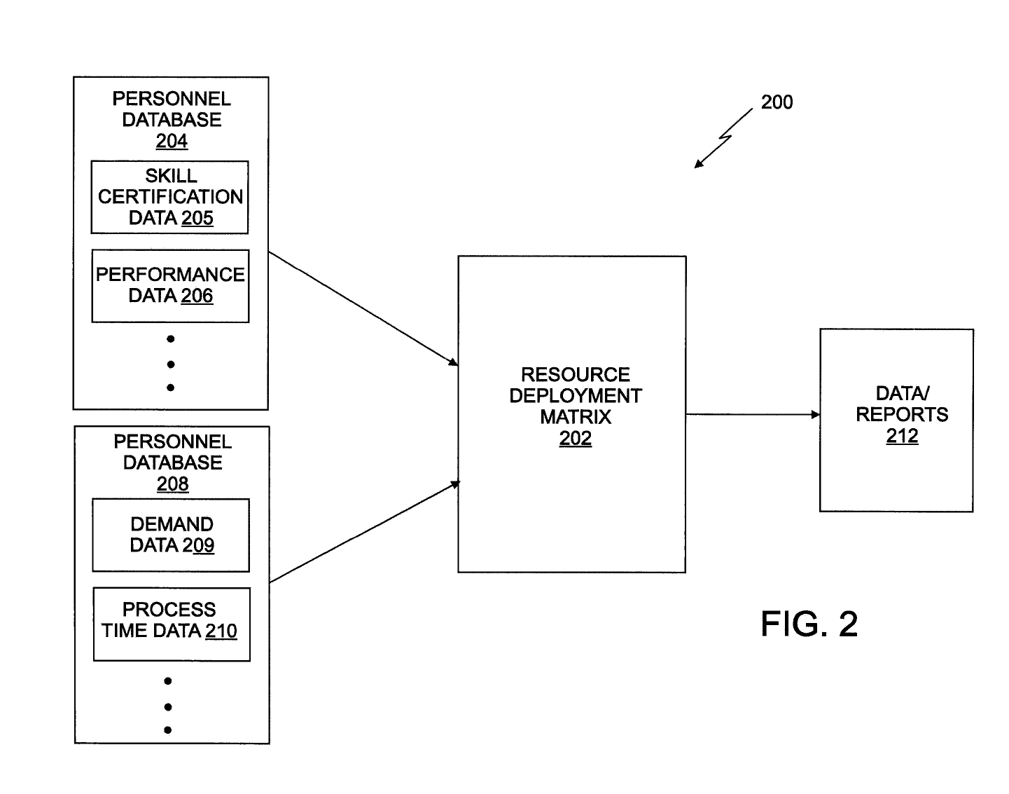

FIG. 2 illustrates an example of a subsystem 200 of the exemplary computer system 100 that is configured for effective employee assignment. Exemplary subsystem 200 may be included in server 102, client device(s) 130, and/or other device(s) 140, e.g., implemented in hardware and/or software. Subsystem 200 includes resource deployment matrix (“RDM”) 202, which is in communication with personnel database 204 and planning database 208. Personnel database 204 may include personnel or employee related data such as skill certification data 205 and performance data 206, examples of which will be discussed below. Planning database 208 may include planning or other operation related data such as demand data 209 and process time data 210, examples of which will also be discussed below. RDM 202 may also output data and/or reports 212 regarding effective employee assignment.

RDM 202 is configured to determine a number of employees needed to perform each of a plurality (e.g., two or more) of tasks based on a demand amount for each task obtained from planning database 208 and to determine a skill flexibility index (“SFI”) of each of the employees that includes a scaled index of a total number of skill certifications of each employee to perform the plurality of tasks based on skill certification data 205 from personnel database 204. RDM 202 is also configured to determine a job quality index (“JQI”) of each of the employees that includes a scaled index of a job performance quality rating of each employee based on job performance data 206 from personnel database 204 and to determine a minimum acceptable JQI (“min. JQI”) for each of the plurality of tasks based on user input data and/or demand data from planning database 208. Furthermore, RDM 202 is configured to, for each task, in an order from the task with a highest min. JQI to the task with a lowest min. JQI, assign each employee to the task that has a JQI that is higher than or equivalent to the min. JQI of the task in an order from each employee with a lower SFI and a higher JQI to an employee with a higher SFI and a lower JQI until the number of employees needed to perform the task is assigned or there are no more available employees to assign to the task that have a JQI that is higher than or equivalent to the min. JQI of the task. Additionally, RDM 202 is configured to output data indicating respective assignments of the employees to the tasks for computation or user review. An exemplary operation of subsystem 200, including RDM 202, will be described below.

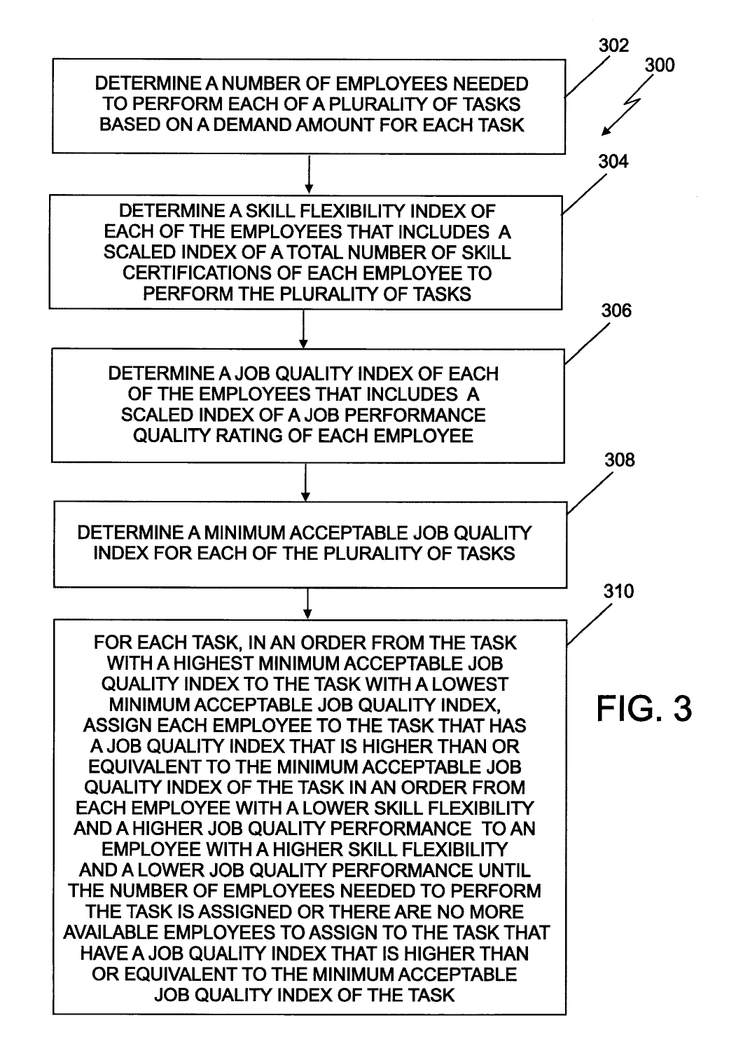

FIG. 3 illustrates an example of a method 300 for effective employee assignment, which is executable, for example, on the exemplary server device 102 of FIG. 1 (e.g., as a computer program product). Exemplary method 300 may also describe an exemplary operation of exemplary subsystem 200. In block 302, a number of employees needed to perform each of a plurality of tasks based on a demand amount for each task is determined. For example, RDM 202 may compute the number of employees needed based on demand data 209 and process time data 210 from planning database 208. The number of employees needed may be computed as, rounded (e.g., down) to the nearest integer, the demand amount multiplied by a raw processing time for the task divided by a number of daily (or other periodic) work hours, for example, according to the equation:

$$TotalWorkload = round ( \frac{( Demand * RawProcessTime )}{Hours ( perday )} ) \qquad ( EQ 1 )$$

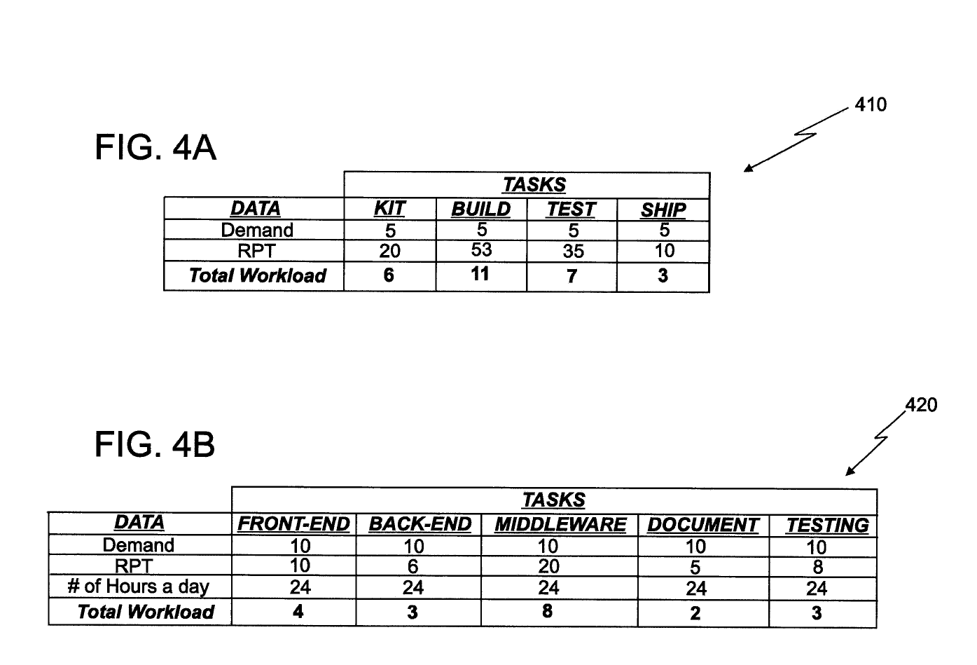

In the foregoing equation EQ1, “TotalWorkload” represents the number of employees needed, “Demand” represents the demand amount, “RawProcessTime” represents the raw processing time for the task, and “Hours(perday)” represents the number of daily work hours. In this regard, FIGS. 4A and 4B illustrate exemplary tables 410, 420 that show exemplary computation parameters and results of the number of employees needed (i.e., “Total Workload”) based on the demand amount (i.e., “Demand”), the raw processing time for the task (i.e., “RPT”), and the number of daily work hours (i.e., “# of flours a day”). Table 410 may correspond, for example, to tasks performed for one or more manufacturing processes. Table 420 may correspond, for example, to tasks performed for one or more software development processes.

In block 304, a skill flexibility index (“SFI”) of each of the employees is determined that includes a scaled index of a total number of skill certifications of each employee to perform the plurality of tasks (e.g., where a greater SFI indicates a greater skill flexibility). For example, RDM 202 may compute the SFI of each employee based on skill certification data 205 from personnel database 204. The SFI may be computed as, rounded to the nearest integer, a determined maximum SFI value multiplied by a ratio of a total number of skill certifications of each employee to perform the plurality of tasks divided by a maximum available number of skill certifications that each employee can obtain to perform the plurality of tasks, where the resulting SFI is an integer in a range of zero to the determined maximum SFI value. The maximum SFI value may be determined, for example, based on user preference and/or with respect to other parameters and results. The SFI may be computed, for example, according to the equation:

$$SFI = round ( max ( SFI ) * ( \frac{TotalCert}{max ( TotalCert )} ) ) \qquad ( EQ 2 )$$

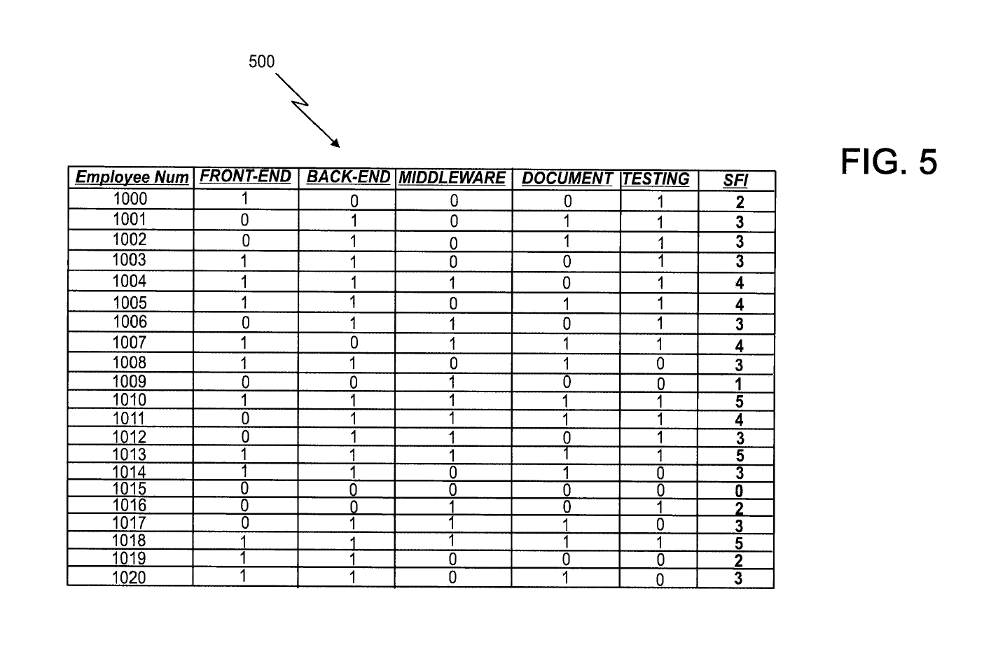

In the foregoing exemplary equation EQ2, “max(SFI)” represents the determined maximum SFI value, “TotalCert” represents the total number of skill certifications of each employee to perform the plurality of tasks, and “max(TotalCert)” represents the maximum available number of skill certifications that each employee can obtain to perform the plurality of tasks As part of computation of the SFI, intermediate results that include an integer value of 0.5 (e.g., 1.5, 2.5, etc.) may be consistently rounded to the nearest even integer (or alternatively to the nearest odd integer) to facilitate consistent computations. In this regard, FIG. 5 illustrates an exemplary table 500 that shows exemplary computation parameters and results of the SFI for a plurality of employees identified by an employee number. In exemplary table 500, the SFI is computed with respect to tasks that are performed, for example, for one or more software development processes. Furthermore, in exemplary table 500, certification to perform a task is indicated by a “1” and a lack of certification is indicated by “0”. Additionally, the maximum SFI value is determined as “5” as used in exemplary table 500. Thus, an SFI of “0” represents a minimum SFI (i.e., indicating an employee having no certifications for the applicable tasks), and an SFI of “5” represents a maximum SFI (i.e., indicating an employee having the maximum available certifications for the applicable tasks). Therefore, among employees having one or more certifications, an employee with an SFI of “1” has the least flexibility (e.g., being assignable to just one task) and an employee with an SFI of “5” has the most flexibility (e.g., being assignable to all tasks).

In block 306, a job quality index (“JQI”) of each of the employees is determined that includes a scaled index of a job performance quality rating of each employee, (e.g., where a greater JQI indicates a greater job quality performance). For example, RDM 202 may compute the JQI of each employee based on performance data 206 from personnel database 204. The JQI may be computed as a ratio of non-compliant task performance divided by overall task performance of an employee (e.g., based on historical job performance). For example, the JQI may be computed according to the equation:

$$JQI = ( ( 1 - \frac{Defects}{Throughput} ) \times 100 ) \qquad ( EQ 3 )$$

In the foregoing exemplary equation EQ3, “Defects” represents non-compliant task performance and “Throughput” represents overall task performance, where each parameter may be expressed as a numerical amount. Furthermore, the results of equation EQ3 provides the JQI as a percentage. In an example where the tasks are performed for one or more software development processes, the JQI may be computed using the following modification of equation EQ3:

$$JQI = ( ( 1 - \frac{Bugs}{LinesofCode} ) \times 100 ) \qquad ( EQ 4 )$$

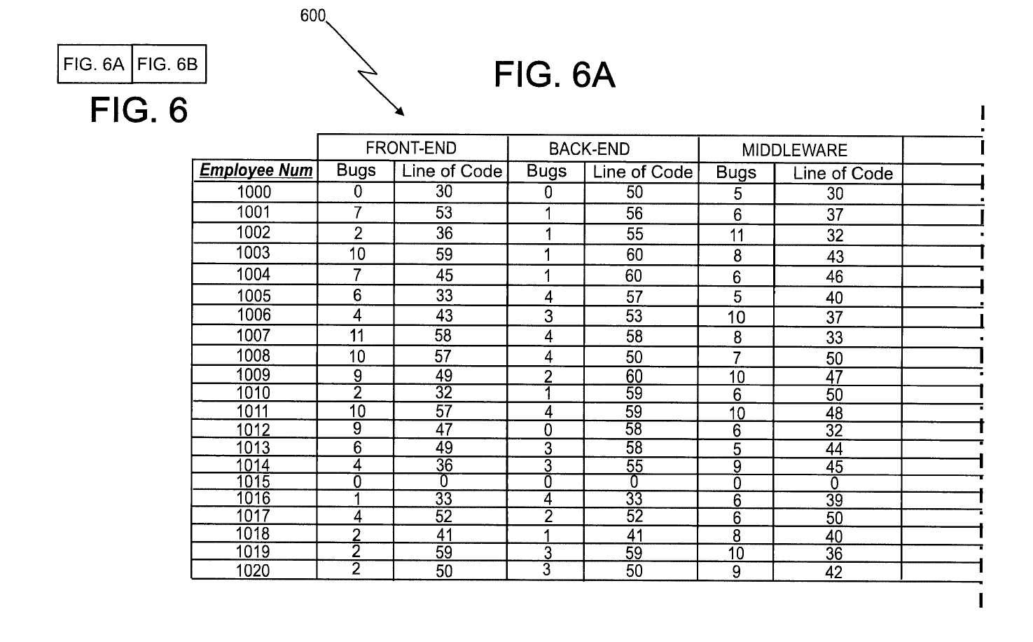

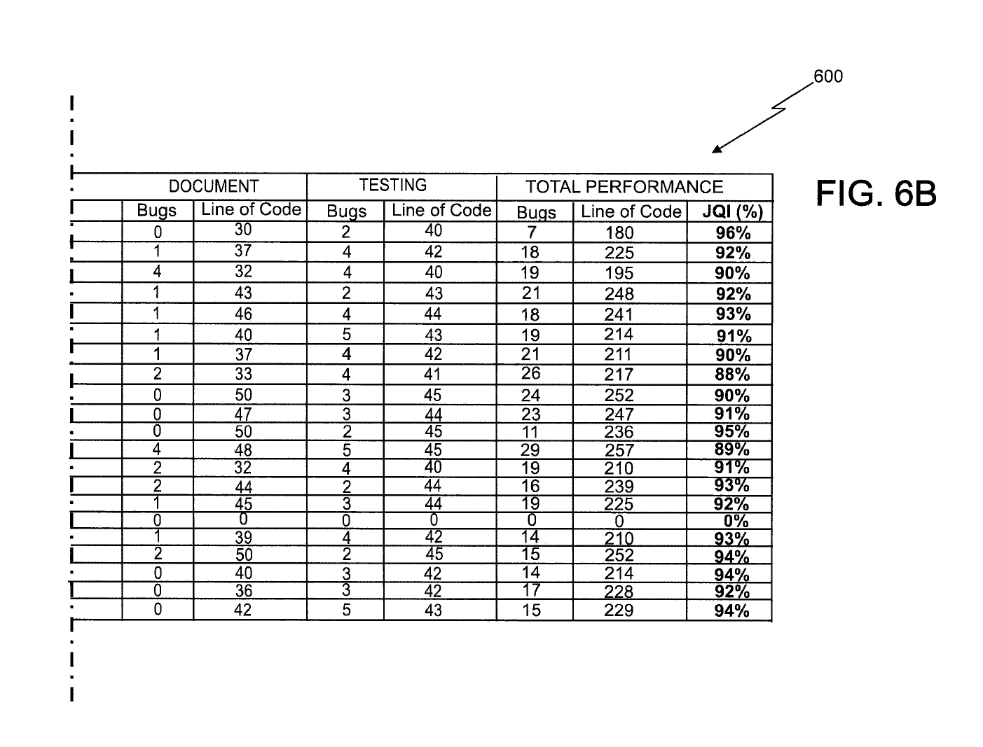

In the foregoing exemplary equation EQ4, “Bugs” represents the number of errors (“bugs”) in software developed in one or more tasks performed by an employee and “LinesofCode” represents the overall number of lines of code in the software. In this regard, FIG. 6 illustrates an exemplary table 600 that shows exemplary computation parameters and results of the JQI (i.e., as a percentage) of each employee, identified by an employee number, for tasks that are performed, for example, for one or more software development processes.

The JQI may be converted from a numerical amount or percentage to a letter value, for example, to facilitate user review and/or additional computation. For example, the JQI may be converted from a percentage to a letter value based on the following exemplary conversion guideline: <60%→E; 61%-70%→D; 71%-80%→C, 81%-90%→B; 91%-100%→A. Different guidelines may be implemented depending on factors such as business goals, customer demands, etc.

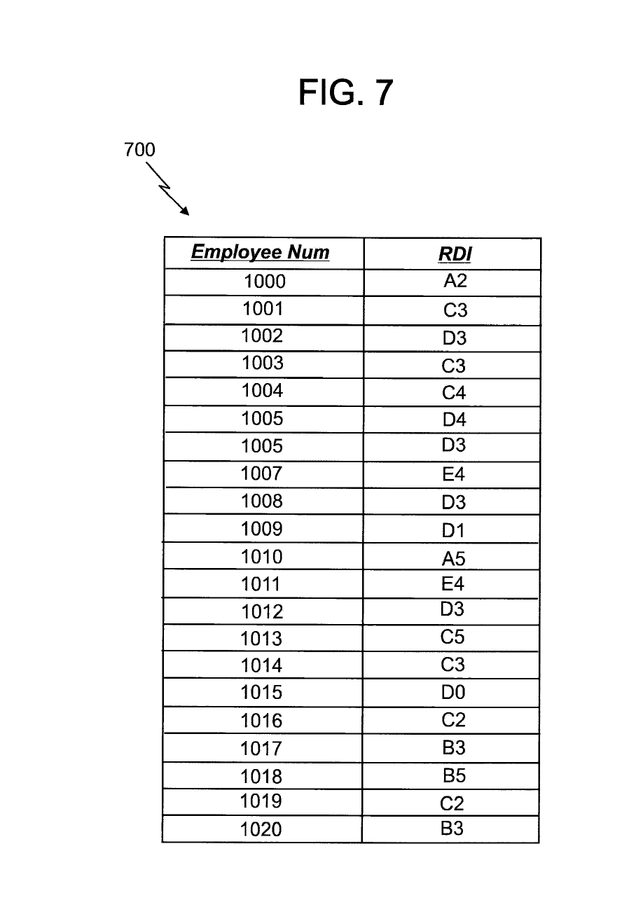

Additionally, the JQI (e.g., as a letter value) and the SFI for each employee may be combined into an alpha-numeric value that can be referred to as a resource deployment index (“RDI”), e.g., to facilitate user review and/or additional computation. For example, an employee who exhibits good performance (e.g., indicated by a high JQI) and high flexibility (e.g., indicated by a high SFI) may have an RDI of “A5” and an employee who exhibits poor performance (e.g., indicated by a low JQI) and low flexibility (e.g., indicated by a low SFI) may have an RDI of “E1”. In this regard, FIG. 7 illustrates an exemplary table 700 that shows an RDI for each employee (identified by an employee number) based on the JQI determined according to the above exemplary guideline with respect to the computation results listed in exemplary table 600 and the SFI computation results listed in exemplary table 500.

In block 308, a minimum acceptable JQI (“min. JQI”) is determined for each of the plurality of tasks. The min. JQI may, for example, be based on user input (e.g., via server 102, client device(s) 130, and/or other device(s) 140) and/or on demand data 209 from the planning database 208. Furthermore, the min. JQI may be based one or more factors, such as business goals, customer demands, etc.

In block 310, for each task, in an order from the task with a highest min. JQI to the task with a lowest min. JQI, each employee is assigned to the task that has a JQI that is higher than or equivalent to the min. JQI of the task in an order from each employee with a lower skill flexibility (e.g., according to the SFI) and a higher job quality performance (e.g., according to the JQI) to an employee with a higher skill flexibility and a lower job quality performance until the number of employees needed to perform the task is assigned or there are no more available employees to assign to the task that have a JQI that is higher than or equivalent to the min. JQI of the task.

In some embodiments, the assignment of employees according to block 310 may include creating (e.g., by RDM 202) a matrix record that includes a plurality of cells. A first column of the cells is populated with a list of identifying information of the employees (e.g., the employee numbers) in an ascending order from each employee with a lower SFI to an employee with a higher SFI. Remaining columns of the cells respectively correspond to each of the plurality of tasks and are populated with the JQI and SFI (e.g., in the form of an RDI) in the remaining columns of the cells corresponding to each task along a row of the cells corresponding to the identifying information of each employee. Then, for each remaining column corresponding to each task, in an order from the task with a highest min. JQI to the task with a lowest min. JQI, until the number of employees needed to perform the task is found or there are no more JQIs in the remaining column that are higher than or equivalent to the min. JQI of the task, the following is performed. Each row of cells is searched in the ascending order for a JQI that is higher than or equivalent to the min. JQI of the task corresponding to each remaining column. Each cell of the matrix record is marked in which the JQI is found that is higher than or equivalent to the min. JQI, thereby indicating an assignment of the corresponding employee to the task and the unavailability of the corresponding employee for assignments to other tasks. If more than one task has a same min. JQI, the columns corresponding to the tasks are searched in the order that the tasks are respectively performed.

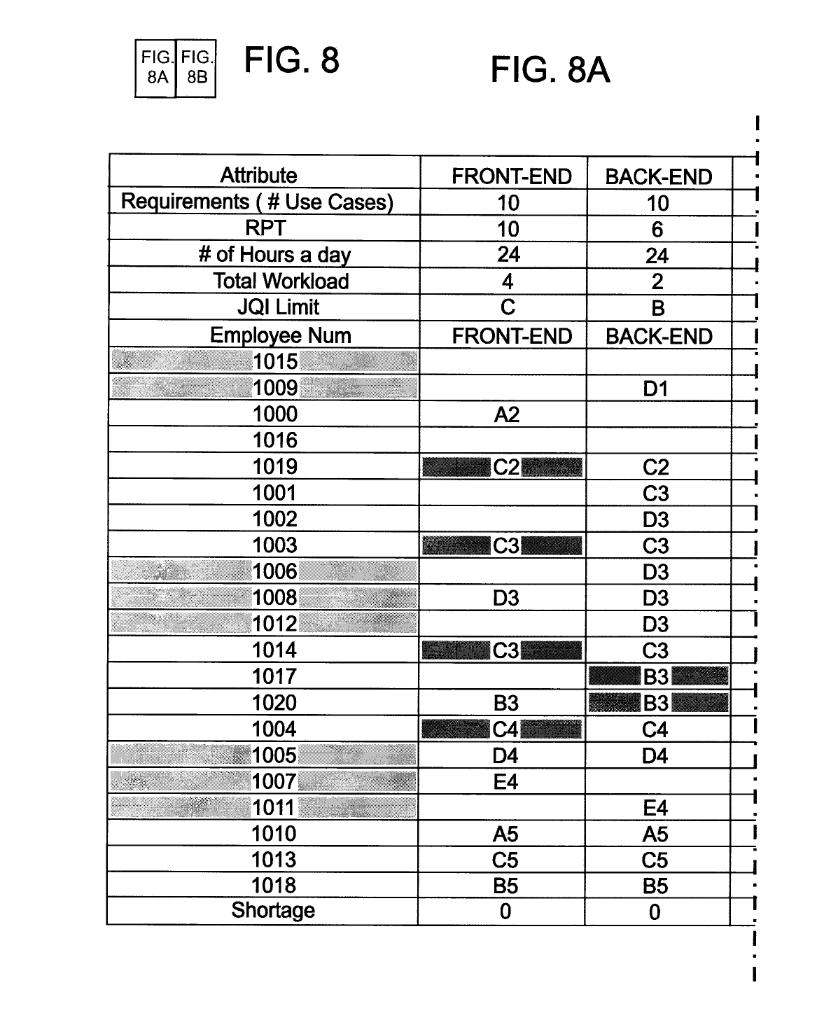

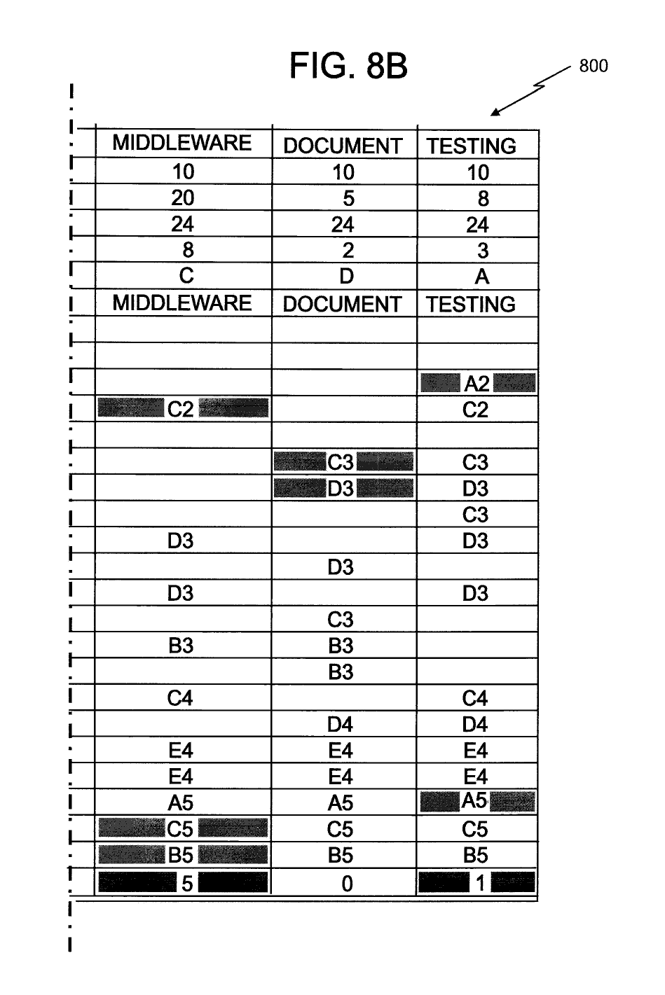

In accordance with the foregoing example, FIG. 8 illustrates an exemplary matrix record 800 that includes a first column listing employee numbers to identify a group of employees. Each of the adjacent remaining columns of the cells respectively correspond to a task that is, for example, performed for one or more software development processes. The cells are populated with the RDI corresponding to each task along a row of the cells corresponding to each employee number. The employee numbers are listed in an ascending order of an RDI that includes a lower SFI (e.g., A1, B1, . . . , E1) to an RDI that includes a higher SFI (e.g., A5, B5, . . . , E5). For each task (i.e., corresponding to each adjacent remaining column), in an order from the task with a highest min. JQI to the task with a lowest min. JQI, the cells in the column have been searched in the ascending order (i.e., as listed top to bottom) for an RDI that includes a JQI that is higher than or equivalent to the min. JQI until the number of employees needed to perform the task was found or there were no more RDIs in the column with JQIs that were higher than or equivalent to the min. JQI of the task. Each cell was marked (e.g., shaded) in which the JQI (i.e., based on the RDI) was found that was higher than or equivalent to the min. JQI, thereby indicating an assignment of the corresponding employee to the task and the unavailability of the employee for assignment to one of the other tasks. In exemplary record 800, the column for the “FRONT-END” task was searched before the column for the “MIDDLEWARE” task was searched, since the former task is performed before the latter task in an exemplary software development process. As also illustrated in FIG. 8, exemplary matrix record 800 may include other data, such as data from personnel database 204 and/or planning database 208 that was used to determine the number of employees needed.

In some embodiments, exemplary method 300 may also include one or more of the following actions (e.g., performed by RDM 202): (1) designating each employee having a high JQI and a low SFI as needing action to obtain certification in other tasks; (2) designating each employee having a low JQI and a high SFI as needing action to improve job quality performance; (3) designating each employee having a JQI that is less than the minimum job quality index of each task and a low SFI as needing action to obtain certification in other tasks and improve job quality performance or to transfer to a different job responsibility; (4) determining that action is needed to improve a business structure if there is a low assignment of available employees to the plurality of tasks or a high unavailability of employees to assign to the plurality of tasks. The indication for such designations and/or determination may be provided in matrix record 800, for example, by marking the cells accordingly. For example, in exemplary record 800 of FIG. 8,, the cells containing employee numbers 1015, 1009, 1006, 1008, 1012, 1005, 1007, and 1011 are marked (e.g., shaded) to indicate that the corresponding employees have not been assigned to a task (i.e., indicating a low assignment of available employees). As another example, exemplary record 800 may also include a row of cells containing the total number of employees for each task that were needed but unavailable (e.g., labeled “Shortage”). In that regard, the cells are marked in the column for the “MIDDLEWARE” task and the “TESTING” task to indicate a shortage of available employees (i.e., that have the corresponding certification and meet the min. JQI).

In some embodiments, exemplary method 300 may also include outputting data indicating respective assignments of the employees to the tasks for computation or user review. For example, data may be output for computation or other manipulation by server 102, client device(s) 130, and/or other device(s) 140. As another example, data may be output by the generation of one or more reports (e.g., such as or similar to exemplary record 800, exemplary table 700, etc.), e.g., for user review.

Exemplary computer system 100, server device 102, and subsystem 200 are illustrated and described with respect to various components, modules, etc. for exemplary purposes. It should be understood that other variations, combinations, or integrations of such elements that provide the same features, functions, etc. are included within the scope of embodiments of the invention. Furthermore, it should be understood that, in some embodiments, exemplary tables 410, 420, 500, 600, 700 and/or exemplary record 800 may present additional data (e.g., totals, sub-totals, etc.) related to and/or facilitative of effective employee assignment.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to exemplary computer system 100, server device 102, and/or subsystem 200, execution of the flow diagram blocks may be implemented with other hardware and/or software architectures that provide the same features, functions, etc. in accordance with exemplary embodiments of the invention.

Exemplary embodiments of the invention can be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for use by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A method for effective employee assignment, the method comprising:
determining a number of employees needed to perform each of a plurality of tasks based on a demand amount for each task;
determining a skill flexibility index of each of the employees comprising a scaled index of a total number of skill certifications of each employee to perform the plurality of tasks, wherein a greater skill flexibility index indicates a greater skill flexibility;
determining a job quality index of each of the employees comprising a scaled index of a job performance quality rating of each employee, wherein a greater job quality index indicates a greater job quality performance;
determining a minimum acceptable job quality index for each of the plurality of tasks; and
for each task, in an order from the task with a highest minimum acceptable job quality index to the task with a lowest minimum acceptable job quality index, assigning each employee to the task that has a job quality index that is higher than or equivalent to the minimum acceptable job quality index of the task in an order from each employee with a lower skill flexibility and a higher job quality performance to an employee with a higher skill flexibility and a lower job quality performance until the number of employees needed to perform the task is assigned or there are no more available employees to assign to the task that have a job quality index that is higher than or equivalent to the minimum acceptable job quality index of the task.

2. The method of claim 1, wherein determining a number of employees needed to perform each of a plurality of tasks comprises computing, rounded to the nearest integer, the demand amount for each task multiplied by a raw processing time for the task divided by a number of daily work hours.

3. The method of claim 1, wherein determining a skill flexibility index of each of the employees comprises computing, rounded to the nearest integer, a determined maximum skill flexibility index value multiplied by a ratio of a total number of skill certifications of each employee to perform the plurality of tasks divided by a maximum available number of skill certifications that each employee can obtain to perform the plurality of tasks, wherein the computed skill flexibility index is an integer in a range of zero to the determined maximum skill flexibility index value.

4. The method of claim 1, wherein determining a job quality index of each of the employees comprises computing a ratio of non-compliant task performance divided by overall task performance.

5. The method of claim 1, wherein assigning each employee to the task comprises:
creating a matrix record that comprises a plurality of cells, wherein:
a first column of the cells is populated with a list of identifying information of the employees in an ascending order from each employee with a lower skill flexibility index to an employee with a higher skill flexibility index; and
remaining columns of the cells respectively correspond to each of the plurality of tasks and are populated with the job quality index and skill flexibility index in the remaining columns of the cells corresponding to each task along a row of the cells corresponding to the identifying information of each employee; and
for each remaining column corresponding to each task, in an order from the task with a highest minimum acceptable job quality index to the task with a lowest minimum acceptable job quality index, until the number of employees needed to perform the task is found or there are no more job quality indexes in the remaining column that are higher than or equivalent to the minimum acceptable job quality index of the task:
searching each row of cells in the ascending order for a job quality index that is higher than or equivalent to the minimum acceptable job quality index of the task corresponding to each remaining column; and
marking each cell of the matrix record in which the job quality index is found that is higher than or equivalent to the minimum acceptable job quality index thereby indicating an assignment of the corresponding employee to the task and the unavailability of the corresponding employee for assignment to one of the other tasks;
wherein, if more than one task has a same minimum acceptable job quality index, the columns corresponding to the tasks are searched in the order that the tasks are respectively performed.

6. The method of claim 1, further comprising:
designating each employee having a high job quality index and a low skill flexibility index as needing action to obtain certification in other tasks;
designating each employee having a low job quality index and a high skill flexibility index as needing action to improve job quality performance;
designating each employee having a job quality index that is less than the minimum job quality index of each task and a low skill flexibility index as needing action to obtain certification in other tasks and improve job quality performance or to transfer to a different job responsibility; and
determining that action is needed to improve a business structure if there is a low assignment of available employees to the plurality of tasks or a high unavailability of employees to assign to the plurality of tasks.

7. A system for effective employee assignment, comprising:
a resource deployment matrix in communication with a personnel database and a planning database and configured to:
determine a number of employees needed to perform each of a plurality of tasks based on a demand amount for each task obtained from the planning database;
determine a skill flexibility index of each of the employees comprising a scaled index of a total number of skill certifications of each employee to perform the plurality of tasks based on skill certification data from the personnel database, wherein a greater skill flexibility index indicates a greater skill flexibility;
determine a job quality index of each of the employees comprising a scaled index of a job performance quality rating of each employee based on job performance data from the personnel database, wherein a greater job quality index indicates a greater job quality performance;
determine a minimum acceptable job quality index for each of the plurality of tasks based on user input data or demand data from the planning database;
for each task, in an order from the task with a highest minimum acceptable job quality index to the task with a lowest minimum acceptable job quality index, assign each employee to the task that has a job quality index that is higher than or equivalent to the minimum acceptable job quality index of the task in an order from each employee with a lower skill flexibility and a higher job quality performance to an employee with a higher skill flexibility and a lower job quality performance until the number of employees needed to perform the task is assigned or there are no more available employees to assign to the task that have a job quality index that is higher than or equivalent to the minimum acceptable job quality index of the task; and
output data indicating respective assignments of the employees to the tasks for computation or user review.

8. The system of claim 7, wherein the resource deployment matrix is configured to determine a number of employees needed to perform each of a plurality of tasks by computing, rounded to the nearest integer, the demand amount for each task multiplied by a raw processing time for the task divided by a number of daily work hours, wherein the raw processing time is also obtained from the planning database.

9. The system of claim 7, wherein the resource deployment matrix is configured to determine a skill flexibility index of each of the employees by computing, rounded to the nearest integer, a determined maximum skill flexibility index value multiplied by a ratio of a total number of skill certifications of each employee to perform the plurality of tasks divided by a maximum available number of skill certifications that each employee can obtain to perform the plurality of tasks, wherein the computed skill flexibility index is an integer in a range of zero to the determined maximum skill flexibility index value.

10. The system of claim 7, wherein the resource deployment matrix is configured to determine a job quality index of each of the employees by computing a ratio of non-compliant task performance divided by overall task performance.

11. The system of claim 7, wherein the resource deployment matrix is configured to assign each employee to the task by:
creating a matrix record that comprises a plurality of cells, wherein:
a first column of the cells is populated with a list of identifying information of the employees in an ascending order from each employee with a lower skill flexibility index to an employee with a higher skill flexibility index; and
remaining columns of the cells respectively correspond to each of the plurality of tasks and are populated with the job quality index and skill flexibility index in the remaining columns of the cells corresponding to each task along a row of the cells corresponding to the identifying information of each employee; and
for each remaining column corresponding to each task, in an order from the task with a highest minimum acceptable job quality index to the task with a lowest minimum acceptable job quality index, until the number of employees needed to perform the task is found or there are no more job quality indexes in the remaining column that are higher than or equivalent to the minimum acceptable job quality index of the task:
searching each row of cells in the ascending order for a job quality index that is higher than or equivalent to the minimum acceptable job quality index of the task corresponding to each remaining column; and
marking each cell of the matrix record in which the job quality index is found that is higher than or equivalent to the minimum acceptable job quality index thereby indicating an assignment of the corresponding employee to the task and the unavailability of the corresponding employee for assignment to one of the other tasks;
wherein, if more than one task has a same minimum acceptable job quality index, the columns corresponding to the tasks are searched in the order that the tasks are respectively performed.

12. The system of claim 7, wherein the resource deployment matrix is further configured to:
designate each employee having a high job quality index and a low skill flexibility index as needing action to obtain certification in other tasks;
designate each employee having a low job quality index and a high skill flexibility index as needing action to improve job quality performance;
designate each employee having a job quality index that is less than the minimum job quality index of each task and a low skill flexibility index as needing action to obtain certification in other tasks and improve job quality performance or to transfer to a different job responsibility; and
determine that action is needed to improve a business structure if there is a low assignment of available employees to the plurality of tasks or a high unavailability of employees to assign to the plurality of tasks.

13. The system of claim 7, wherein the resource deployment matrix is configured to output data indicating respective assignments of the employees to the tasks by generating a report that lists the respective assignments.

14. A computer program product for effective employee assignment, comprising a computer usable medium having a computer readable program, wherein the computer readable program, when executed on a computer, causes the computer to:
determine a number of employees needed to perform each of a plurality of tasks based on a demand amount for each task;
determine a skill flexibility index of each of the employees comprising a scaled index of a total number of skill certifications of each employee to perform the plurality of tasks, wherein a greater skill flexibility index indicates a greater skill flexibility;
determine a job quality index of each of the employees comprising a scaled index of a job performance quality rating of each employee, wherein a greater job quality index indicates a greater job quality performance;
determine a minimum acceptable job quality index for each of the plurality of tasks based on user input data or demand data;
for each task, in an order from the task with a highest minimum acceptable job quality index to the task with a lowest minimum acceptable job quality index, assign each employee to the task that has a job quality index that is higher than or equivalent to the minimum acceptable job quality index of the task in an order from each employee with a lower skill flexibility and a higher job quality performance to an employee with a higher skill flexibility and a lower job quality performance until the number of employees needed to perform the task is assigned or there are no more available employees to assign to the task that have a job quality index that is higher than or equivalent to the minimum acceptable job quality index of the task; and
output data indicating respective assignments of the employees to the tasks for computation or user review.

15. The computer program product of claim 14, wherein the computer readable program, when executed on the computer, causes the computer to determine a number of employees needed to perform each of a plurality of tasks by computing, rounded to the nearest integer, the demand amount for each task multiplied by a raw processing time for the task divided by a number of daily work hours.

16. The computer program product of claim 14, wherein the computer readable program, when executed on the computer, causes the computer to determine a skill flexibility index of each of the employees by computing, rounded to the nearest integer, a determined maximum skill flexibility index value multiplied by a ratio of a total number of skill certifications of each employee to perform the plurality of tasks divided by a maximum available number of skill certifications that each employee can obtain to perform the plurality of tasks, wherein the computed skill flexibility index is an integer in a range of zero to the determined maximum skill flexibility index value.

17. The computer program product of claim 14, wherein the computer readable program, when executed on the computer, causes the computer to determine a job quality index of each of the employees by computing a ratio of non-compliant task performance divided by overall task performance.

18. The computer program product of claim 14, wherein the computer readable program, when executed on the computer, causes the computer to assign each employee to the task by:
creating a matrix record that comprises a plurality of cells, wherein:
a first column of the cells is populated with a list of identifying information of the employees in an ascending order from each employee with a lower skill flexibility index to an employee with a higher skill flexibility index; and
remaining columns of the cells respectively correspond to each of the plurality of tasks and are populated with the job quality index and skill flexibility index in the remaining columns of the cells corresponding to each task along a row of the cells corresponding to the identifying information of each employee; and
for each remaining column corresponding to each task, in an order from the task with a highest minimum acceptable job quality index to the task with a lowest minimum acceptable job quality index, until the number of employees needed to perform the task is found or there are no more job quality indexes in the remaining column that are higher than or equivalent to the minimum acceptable job quality index of the task:
searching each row of cells in the ascending order for a job quality index that is higher than or equivalent to the minimum acceptable job quality index of the task corresponding to each remaining column; and
marking each cell of the matrix record in which the job quality index is found that is higher than or equivalent to the minimum acceptable job quality index thereby indicating an assignment of the corresponding employee to the task and the unavailability of the corresponding employee for assignment to one of the other tasks;
wherein, if more than one task has a same minimum acceptable job quality index, the columns corresponding to the tasks are searched in the order that the tasks are respectively performed.

19. The computer program product of claim 14, wherein the computer readable program, when executed on the computer, further causes the computer to:
designate each employee having a high job quality index and a low skill flexibility index as needing action to obtain certification in other tasks;
designate each employee having a low job quality index and a high skill flexibility index as needing action to improve job quality performance;
designate each employee having a job quality index that is less than the minimum job quality index of each task and a low skill flexibility index as needing action to obtain certification in other tasks and improve job quality performance or to transfer to a different job responsibility; and
determine that action is needed to improve a business structure if there is a low assignment of available employees to the plurality of tasks or a high unavailability of employees to assign to the plurality of tasks.

20. The computer program product of claim 14, wherein the computer readable program, when executed on the computer, causes the computer to output data indicating respective assignments of the employees to the tasks by generating a report that lists the respective assignments.
